(19) United States
(12) Patent Application Publication
(10) Pub. No.: US 2025/0271878 A1
(43) Pub. Date: Aug. 28, 2025

(54) VALVE ARRANGEMENT, VALVE UNIT AND METHOD FOR CONTROLLING A VALVE UNIT IN A VALVE ARRANGEMENT

(71) Applicant: Festo SE & Co. KG, Esslingen (DE)

(72) Inventors: Ralf STARZMANN, Reichenbach (DE); Hans-Jürgen PLACH, Esslingen (DE); Eduard WENSKE, Kornwestheim (DE); Andreas MEYER, Aichwald (DE)

(21) Appl. No.: 19/064,108

(22) Filed: Feb. 26, 2025

(30) Foreign Application Priority Data
Feb. 28, 2024 (DE) 10 2024 105 685.1

(51) Int. Cl. G05D 7/06

(52) U.S. Cl. CPC G05D 7/0652

(57) ABSTRACT

A valve assembly for supplying compressed air consumers, with a base plate on which several valve slots are formed, each of which has a fluid interface and a communication interface and with at least one valve unit which is arranged on one of the valve slots and is connected to the fluid interface and the communication interface. The communication interfaces are connected to a controller to provide electrical signals to the communication interfaces and to receive electrical signals from the communication interfaces. The control unit is designed to read a memory module of the respective valve unit and, depending on a result of the read-out process, to block or enable program modules that are stored in a control memory of the control unit and to use released program modules for controlling the respective valve unit.

### CROSS REFERENCE TO RELATED APPLICATION

The present application claims the benefit of German application DE 102024105685.1, filed Feb. 28, 2024, which is incorporated herein by reference.

### BACKGROUND OF THE INVENTION

The invention relates to a valve assembly for supplying compressed air consumers, with a base plate on which several valve slots are formed, each of which has a fluid interface and a communication interface, wherein the communication interfaces are connected to a control unit designed to provide electrical signals to the communication interfaces and to receive electrical signals from the communication interfaces, and with at least one valve unit which is arranged at one of the valve slots and which is connected to the fluid interface and the communication interface. Furthermore, the invention relates to a valve unit and a method for controlling a valve unit in a valve assembly.

WO 1994/04831 A1 discloses an electro-pneumatic control device having a valve station configured as a module, which has a fluid distributor equipped with a plurality of valves, as well as electric valve drives and a central electronic control unit supplying the electrical actuation signals for the valve drives.

### SUMMARY OF THE INVENTION

The object of the invention is to provide a valve assembly, a valve unit and a method for controlling a valve unit in a valve assembly, with which an advantageous adaptation to different operating conditions is made possible.

This object is solved according to a first aspect of the invention for a valve assembly in that the control unit is designed to read a memory module that is assigned to the respective valve unit and, depending on a result of the read-out operation, to block or enable program modules that are stored in a control memory of the control unit and, in particular, to use only enabled program modules for controlling the respective valve unit.

A valve assembly of this kind can be used, for example, in the field of factory automation to supply compressed air-driven actuators, in particular pneumatic cylinders, with the compressed air flows required for performing movements in a production plant. It has been known for a long time to choose a modular design for the valve assembly, in which a base plate, which forms the mechanical base structure for the valve assembly, has several valve slots or plug-in locations, each of which has a fluid interface and a communication interface, whereby a valve unit can be plugged into each of these valve slots and is supplied with compressed air which is provided from the fluid interface and is supplied with electric communications signals which are provided from the communication interface.

The valve unit comprises an electrically actuable valve, for example a solenoid valve or a piezo valve, which can be switched over, for example between a closed state and an open state, by means of electrical signals which can be supplied to the valve unit via the communication interface. The electrically actuable valve preferably serves as a pilot valve for a pneumatically actuated main valve, which can also be integrated into the valve unit and which can be switched between a closed state and an open state depending on the switch position of the pilot valve, so that a large compressed air flow, which is supplied to the respective valve unit via the fluid interface, can be influenced with a relatively small amount of electrical energy.

For the control of the valve units, the valve assembly includes a control unit that has the task of coordinating all the processes necessary for the operation of the valve assembly and of providing control signals for the valve units. The control unit thus includes those components of the valve assembly that are designed to receive, process and send signals. For example, the control unit is designed to process sensor signals from sensors that are assigned to the valve units or to the fluid consumers that are assigned to the valve units. These sensor signals are provided to the control unit via an input module of the valve assembly, for example, to determine information for steering (open loop) the valve units, in particular for controlling (closed loop) the valve units. For this purpose, the control preferably includes a computer program with which incoming information in the form of input signals can be processed and can be output in the form of output signals.

It is preferably provided that the control includes electric output stages with which output signals serving as control signals can be converted, for example, into coil currents or piezo signals for the connected valve units.

The control unit can also be designed to receive electrical signals that can be provided by the valve units via the communication interfaces, wherein these electrical signals can be, for example, status messages that are transmitted directly via the communication interfaces.

In such valve assemblies, it is also known that the control unit can also determine information about the respective valve units during bidirectional communication carried out via the communication interfaces with the valve units. This information relates to the valve type installed in the respective valve unit. Considering the valve type allows the control unit to operate the respective valve unit in a beneficial manner.

According to the invention, it is envisaged that the control unit is designed to read out a memory module, which is assigned to the valve unit arranged at the respective valve slot, via the respective communication interface. It may be envisaged that the memory module is mechanically connected to the valve unit and can be read out by the control unit via the communication interface of the respective valve slot. Alternatively, it is envisaged that the memory module is arranged at the respective valve slot of the base plate, in particular at the communication interface, and can thus be read out directly by the control unit without the need for access to the valve unit arranged at the respective valve slot.

During a computer program running in the control unit being executed, the control unit uses the information read out from the memory module of the respective valve unit to determine whether the respective valve unit is assigned one authorization or several authorizations to use one or more program modules stored in a control memory of the control unit. These program modules represent predefined functions that can be performed by the control unit in conjunction with the respective valve unit and that enable an extension of the range of functions for the respective valve unit compared to a pure basic function of the valve unit (opening and closing the electrically actuated valve and, if necessary, opening and closing the pneumatically actuated main valve). Such program modules may, for example, be directed to a specific switching behavior of the valve unit and/or to the execution of diagnostic processes and/or the execution of operating data storage and/or operating data evaluations for the respective valve unit.

If the control unit determines that the read information contains one or more authorizations for the use of program modules, which can be done for example by comparing the information with an enablement table stored in the control unit, those program modules for which there is a match between the read information and the enablement table can be used for the subsequent control of the respective valve unit. If the read information does not contain any authorizations, the controller can either block the non-released program modules for use with the respective valve unit, thus preventing the use of these program modules, or simply not use the non-released program modules for the respective valve unit.

Regarding the information stored in the memory module assigned to the respective valve unit, which provides the controller with information about whether and to what extent program modules may be used for this valve unit, it is a kind of activation code that is preferably stored in the respective memory module in a tamper-proof and copy-protected manner. The program modules that can be enabled for processing in the control unit by these activation codes are stored in the control memory. The information stored in the memory module assigned to the valve unit is thus used solely to enable the program modules in the control unit but does not have any further information content regarding the function of the program module to be enabled.

In addition, information can also be stored in the electronic memory of the memory module, with which a parameterization of the control for the (open loop or closed loop) control of the respective valve unit can be carried out, whereby parameterization can also be used independently of the released program module(s).

Advantageous further developments of the invention are the subject of the sub-claims.

It is useful if the memory module of the valve unit has an electronic memory, in particular an EPROM, EEPROM or flash memory. This means that complex information can also be stored in the memory module to meet the requirements of counterfeit protection and copy protection. On the one hand, it is important to avoid the unauthorized use of program modules that have not been paid for by the customer when purchasing the respective valve unit. On the other hand, it is also important to avoid the use of program modules for valve units that are not intended for these valve units and could thus possibly cause damage or at least malfunctions to the respective valve units. An electronic memory is understood to be a device in which many semiconductor switches on a microchip are used to store the required information. It is preferred that the electronic memory can hold the stored information even without a permanent electrical power supply. As examples, the electronic memory may be an EPROM (Erasable Programmable Read-Only Memory), an EEPROM (Electrically Erasable Programmable Read-Only Memory) or a flash memory (digital memory chip for non-volatile storage without power consumption).

It is advantageous if the control unit includes a central processing unit (CPU, in particular a microprocessor) designed for external communication with a higher-level control unit and for internal communication with the communication interfaces. This central processing unit forms a component of the control unit and is designed to convert control commands provided by a higher-level machine control or plant control via a communication link, in particular a bus connection or an IO-Link connection, into control signals for the valve units.

This central processing unit has a microcontroller or microprocessor that is designed to execute the computer program belonging to the control unit. The central processing unit can be connected to a higher-level machine control or system control via a communication link, for example a bus connection (Profibus, Profinet, EtherCat, . . . ), and for this purpose converts incoming control commands into control signals for the valve units via the bus connection. For the internal communication between the central processing unit and the communication interfaces, either serial communication via an internal bus system of the valve assembly or parallel communication via a multiplicity of parallel signal lines, also referred to as a multi-pole connection, can be provided. It is preferably provided that the control signals of the central processing unit are converted into control currents for the valve units via electrical output stages associated with the control or the communication interfaces.

Furthermore, the central processing unit can be designed to process sensor signals from sensors that are assigned to the valve units or to the fluid consumers that are assigned to the valve units, to determine information for controlling the valve units, in particular for controlling (closed loop) the valve units or the behavior of the fluid consumers.

For example, a program module that is enabled for a specific valve unit can include a special controller (realized in program code) that is used to enable favorable control of the valve unit. Since programming this controller can be very time-consuming, the controller is not provided as standard for the respective valve unit, but only if the user of the valve assembly has ordered and paid for the activation of this controller when ordering the valve unit. Only in this case is it envisaged that the memory module contains the information in the form of an activation code, which is intended to enable the associated program module, which is stored in the control unit, to be used to control this valve unit.

In a further development of the invention, it is envisaged that the control unit will comprise a plurality of communication processors which are assigned to the respective communication interfaces and which are designed for internal bus communication with the central processing unit and for reading the respectively assigned memory module via the respective communication interface, which is in particular designed as a serial peripheral interface (SPI). The communication processors can each be connected exclusively to a respective valve slot.

Alternatively, it is envisaged that at least one communication processor, and preferably all communication processors, are connected to more than one valve slot. In this case, the communication processors can be regarded as bus subscribers of an internal bus network that is formed in the valve assembly to ensure a scalability for the valve assembly that is as flexible as possible and not limited by the number of available electrical lines. The task of the communication processors can consist of extracting control signals of the central processing device, which are intended for the valve unit associated with the respective communication interface, from the bus communication and converting them into corresponding control signals for an electrical output stage arranged locally at the valve slot, which then makes the electrical supply, in particular the electrical coil current, available for the valve unit.

In addition, or as an alternative, the communication processor can be designed to process signals, in particular sensor signals, of the valve unit connected to the communication interface. This signal processing can, for example, include a signal amplification of the incoming signals, if necessary an analog-digital conversion of the incoming signals and then a conversion of the signals into the coding of the bus protocol. Another task of the communication processor is to determine whether the valve unit connected to the communication interface is equipped with a memory module. If this is the case, the communication processor can read the memory contents of the memory module of the connected valve unit and convert them into the coding of the bus protocol and then transmit them via the bus connection to the central processing unit of the control unit. Preferably, the communication interface is designed as a serial peripheral interface (SPI) and the communication processor is adapted to communicate with the valve unit and with the memory module in accordance with this communication standard.

In addition, or alternatively, the communication processors can also directly perceive the control process for the associated valve unit. For example, the communication processors can generate control signals locally and individually adapted to the respective valve unit, provided that individual parameters for the respective valve unit are stored in the memory module, for example, which are transmitted via the communication interface and the communication processor coupled to it during the read-out process anyway. The communication processor can also be designed to read the respective memory module of the associated valve unit individually and to execute the release of program modules as a function of the read-out information as well as the control of the valve unit with the released program modules. In this case, it may be provided that the individual communication processor has its own local memory for the program modules. Alternatively, it may be provided that the communication processor accesses the program modules stored in the central processing unit based on the determined activation codes and stores them in its own main memory for local processing.

The communication processor can also be configured as an assembly of several processors optimized for specific purposes. For example, one of these processors can be optimized for bus communication, while another of these processors is designed for calculating control signals for the valve unit and a third processor is responsible for managing the program modules and the activation codes.

It is preferred that the control unit is designed to carry out cyclic or acyclic recurring read access to the memory module or to carry out a cyclic or acyclic recurring write/read access, for storing usage information of the valve unit, to the memory module. The cyclic or acyclic recurring read access to the memory module is intended to ensure that the valve unit connected to the communication interface is authorized to use the control provided by the control unit. This function is of particular interest if the valve units and the valve assembly are also designed for a replacement of the valve units during operation of the valve assembly (hot swap function). Cyclic read access can, for example, be carried out repeatedly after a predetermined number of bus cycles of the usually clocked bus communication between the central processing unit and the communication processors. An acyclic read access can, for example, be carried out when a communication load between the central processing unit and the communication processors connected to it is below a predetermined threshold.

According to a second aspect of the invention, the problem is solved by a valve unit that is designed for use in a valve assembly and has a valve housing in which a fluid channel is formed, which fluid channel extends from an inlet connection to an outlet connection and which has a valve seat, a valve member being arranged in the fluid channel, which valve member is movable between a blocking position, in which it sealingly bears against the valve seat and blocks a fluid flow in the fluid channel, and a release position, in which it is arranged at a distance from the valve seat and allows a fluid flow in the fluid channel, an electric actuator being arranged in the valve housing and being designed to provide a movement for the valve member, at least two control contacts which are fixed to the valve housing being formed on an outer surface of the valve housing and being electrically connected to the actuator, and a memory module being arranged on the outer surface of the valve housing, which memory module has, in particular on an end face facing away from the valve housing, a memory interface which is connected, in particular exclusively, to an electronic memory accommodated in the memory module. The control contacts and the memory interface being designed for coupling to a communication interface of a valve assembly.

The valve unit may comprise a single fluid channel that extends in a valve housing from an inlet connection to an outlet connection and that is provided with a valve seat. In a valve unit designed in this way, an axial sealing effect is typically provided between the valve member and the valve seat, so that the valve unit is also referred to as a seat valve. However, a design as a slide valve is also possible, in which a radial sealing effect is provided between the valve member and the valve seat. Furthermore, a design as a diaphragm valve can also be provided, in which a sealing diaphragm is provided between the fluid channel and the valve seat formed therein and the valve member, which is also designed to close the valve seat in the event of a corresponding movement of the valve member.

Alternatively, the valve unit can be provided with several fluid channels formed separately in the valve housing, with separately formed valve seats, which open out at individual inlet and outlet connections. For this purpose, the valve member is preferably designed as a valve slide, the preferably linear movement of which between a first functional position and a second functional position enables a synchronized influence on a plurality of valve seats.

The valve unit can be realized, for example, as a 2/2-way valve, as a 3/2-way valve, as a 5/2-way valve or in another combination of valve positions and connections.

To enable the movement of the valve member between the first functional position and the second functional position and, if necessary, a further intermediate position between these two functional positions, an electric actuator is provided, which, purely by way of example, can be a piezo bender or a linear-acting piezo actuator or a magnetic drive with at least one magnetic coil. Depending on the technical design of the electric actuator, a specific electric control of the respective valve unit is required, which is provided by a control unit of a valve assembly to which the valve unit can be coupled. At least two control contacts are provided on a valve housing of the valve unit for the purpose of coupling electrical energy into the valve unit, via which, for example, a coil current for a magnetic drive of the valve unit can be provided. These control contacts are arranged on the outer surface of the valve housing and can be designed, for example, as electrically conductive contact surfaces, as electrically conductive contact springs or as electrically conductive contact pins.

Furthermore, a memory module is arranged on the outer surface of the valve housing, preferably on the same outer surface on which the control contacts are formed, which is provided with an electrically addressable memory interface. This memory interface is electrically connected to an electronic memory formed in the memory module and is designed for electrical coupling to a communication interface of a valve slot of a valve assembly.

It is preferably provided that the at least two control contacts and the memory interface are arranged on the valve housing in such a way that all electrical connections between a communication interface of the valve assembly, the control contacts and the memory interface are established by a plugging operation which is preferably carried out in exactly one, in particular linear, spatial direction relative to a valve assembly.

In an advantageous further development of the valve unit, it is envisaged that the memory module is designed as a separate assembly and is connected mechanically to the valve housing, in particular exclusively in this way. This means that the memory module can be retrofitted to a valve unit that may already be in use at any time. Furthermore, the design of the storage module as a separate assembly avoids the need for a design effort that goes beyond the provision of a purely mechanical coupling between the valve housing and the storage module, even for valve units that are to be delivered optionally with or without the storage module. It is particularly preferred that the storage module is connected to further components of the valve unit only mechanically, but not electrically or electronically, whereby technically complex plug connections or other electrical contacting measures can be avoided.

In a further design of the valve unit, it is envisaged that the memory interface has at least two memory contacts that are designed for electrical connection to the communication interface of the valve assembly to enable read access or read/write access from the valve assembly to the electronic memory. Preferably, the memory contacts are resilient contact tongues or contact springs made, for example, of metallized plastic or metal. With a design of the memory contacts of this kind, it may be sufficient for the communication interface of the valve assembly to have only the electrically conductive contact surfaces associated with the memory contacts, which can be realized, for example, on a printed circuit.

Preferably, the memory interface of the valve unit has an optical interface that is designed for contactless optical energy coupling and for contactless optical signal output between an optical read-out device of the communication interface of the valve unit and the electronic memory accommodated in the memory module, to enable read access or read/write access to the electronic memory. In this variant of the memory interface, the memory interface and the communication interface of the valve assembly form an optocoupler that can be used for both contactless power transmission and contactless signal transmission. In a first embodiment of the memory module, a unidirectional energy coupling from the communication interface into the memory module and a unidirectional signal transmission from the memory module to the communication interface for pure read access can be provided. In a second embodiment of the memory module, a bidirectional signal transmission between the communication interface and the memory module can be provided in combination with unidirectional energy coupling from the communication interface into the memory module for read/write access from the communication interface to the memory module.

It is advantageous if the valve housing of the valve unit comprises a fluid module and an actuator module, with the fluid module comprising the fluid channel, the inlet connection, the outlet connection, the valve seat and the valve member, wherein the actuator module comprises the electric actuator and the control contacts and is designed for the attachment of the storage module, and wherein the fluid module and the actuator module are designed as separate subassemblies that are mechanically connected to one another. In this design of the valve unit, a structural separation is provided between the fluid-conducting fluid module and the electrically operable actuator module, whereby each of these two assemblies can be ideally adapted to the specific requirements. A coupling between the two subassemblies is preferably provided only in the mechanical sense, wherein this coupling comprises, on the one hand, the mutual fixing of the two subassemblies to one another and, on the other hand, the transmission of the movement of the electric actuator in the actuator module to the valve member in the fluid module.

In an advantageous further development of the valve unit, it is provided that the storage module has at least one latching means, from the group consisting of latching nose and latching undercut, on a second end face facing away from the first end face, which is designed for a form-fitting mechanical coupling with the valve housing. The at least one latching means can be used to mechanically secure the storage module to the valve housing, in particular to the actuator module of the valve housing. This latching connection is preferably designed in such a way that the storage module can no longer be removed after it has been attached to the valve housing without having to accept destruction of the storage module. This is to prevent memory modules from being exchanged between different valve units that may have different electrical properties and could lead to malfunctions or faults due to incorrect control based on the information stored in the memory module.

According to a third inventive aspect, the problem is solved by a method for controlling a valve unit in a valve assembly, comprising the following steps: a read access is performed by a controller of a valve assembly to an electronic memory of a memory module attached to a valve unit coupled to the valve assembly, processing a data set stored in the electronic memory in the control unit of the valve assembly in order to identify at least one activation code contained in the data set, releasing a program module determined by the activation code, which program module is stored in a control memory of the control unit, and carrying out a control operation of the valve with the released program module.

With such a procedure, differently configured valve units can be controlled, which differ from one another in the absence or presence of a memory module and, in the presence of a memory module, in the different data sets contained in the memory module. If the valve unit does not have a memory module, this is detected when the read access is performed, and the control unit of the valve assembly does not enable any program modules. In this case, the valve is actuated exclusively with the standard actuation routines stored in the control unit. If, however, it is determined during the read access that the valve unit is equipped with a memory module, the data record stored in the electronic memory of the memory module is read and this data record is transmitted to the control unit. The control unit processes the read-out data record to identify one or more activation codes contained in the data record, which can then be used by the control unit to activate one or more program modules to be able to carry out targeted control of the valve unit with the help of the one or more program modules.

### BRIEF DESCRIPTION OF THE DRAWINGS

An advantageous embodiment of the invention is shown in the drawing.

FIG. 1 shows a schematic perspective view of a valve assembly comprising a plurality of valve units.

FIG. 2 shows a front view of a memory module.

FIG. 3 shows an exploded view of the memory module according to FIG. 2.

FIG. 4 shows a strictly schematized block diagram of a valve assembly with valve units attached to it.

FIG. 5 shows a flow diagram for recognizing and processing activation codes in the valve assembly.

### DETAILED DESCRIPTION

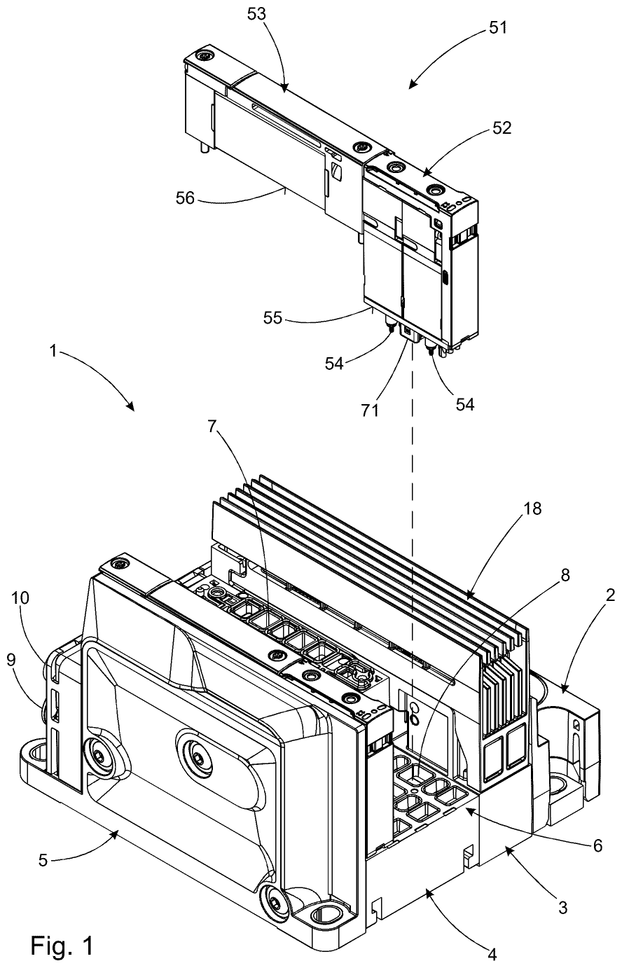

A valve assembly 1, shown in FIG. 1, is designed as a modular and scalable system and is used to supply compressed air to a plurality of compressed air consumers, such as pneumatic cylinders, for example, which are not shown. For this purpose, the valve assembly 1 comprises a connection module 2, a control unit 3, a base plate 4 and an end plate 5, which are mechanically coupled to form a composite and between which electrical connections, not shown in more detail, for transmitting electrical signals and electrical power and/or fluid connections for forwarding compressed air can exist. For reasons of space, a silencer module 18 is placed on the control unit 3, through which exhaust air from the valve assembly 1 can be released into the environment in a sound-damped manner.

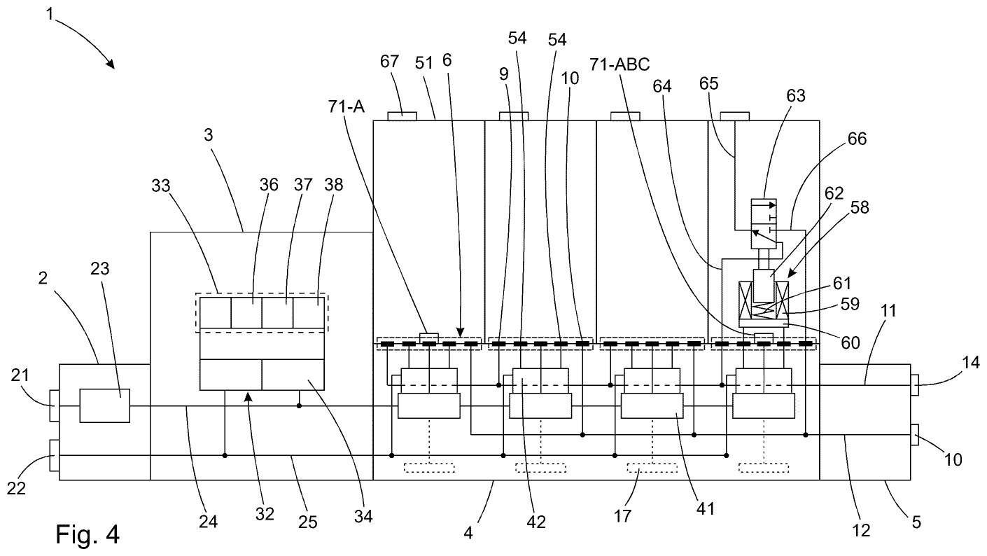

The relationships between the actuator module 2, the control unit 3, the base plate 4 and the end plate 5 are shown in the strictly schematic representation of FIG. 4.

By way of example, the connection module 2 has a communication connection 21 that is designed for communication between the control unit 3 and a higher-level control unit, in particular a machine control unit like an programmable logic controller (PLC), that is not shown. Preferably, communication with the higher-level control unit takes place via a field bus system. Furthermore, the connection module 2 has a power connection 22, which is designed to feed electrical energy into the valve assembly 1. Preferably, the electrical energy is provided independently of the existence of the communication connection with the higher-level control unit. As a purely exemplary example, a bus coupler 23 is incorporated in the connection module 2, which has the task of converting the bus protocol used for communication with the higher-level control, which is not shown, into an internal bus protocol, which is made available via a bus line 24 to the components of the valve assembly 1, which are described in more detail below.

The control unit 3 is connected to the connection module 2 via the bus line 24 and via a supply line 25 connected to the energy connection 22. By way of example only, it is envisaged that both the bus line 24 and the supply line 25 have several individual conductors, not shown in more detail, to enable signal transmission and supply voltage transmission to the other components of the valve assembly 1.

As can be seen from the schematic representation in FIG. 4, the control unit 3 comprises a central processing device 32, which is exemplified by a microprocessor and is designed to execute a computer program stored in a memory device 33. By way of example, the central processing device 33 is connected to the bus line 24 via a communication module 34. The task of the communication module 34 is to extract information directed to the central processing unit from the bus protocol that is transmitted via the bus line 24, and to couple information from the central processing unit 32 onto the bus line 24 for forwarding to other bus subscribers.

The computer program running in the central processing unit 32 is set up to process information from valve units 51, which are connected to the central processing unit 32 via communication interfaces 8 in the base plate 4 and the bus line 24, and/or to provide control signals to the valve units 51. In particular, the computer program is set up to manage authorizations for the use of program modules 36, 37, 38 that are stored in the storage device 33. In this context, it is envisaged that each of the valve units 51 arranged at one of the valve slots 6 of the base plate 4 has an individual authorization profile which is stored in a memory module 71 of the respective valve unit 51.

Alternatively, it may also be provided that the memory device is designed independently of the valve unit 51 and is connected to a memory interface 17, which is drawn in dashed lines in the schematic representation of FIG. 4. In this case, the memory device can be designed, for example, in the manner of a miniature memory card, such as a mini SD card or a mini SIM card, which contains the electronic memory. In deviation from the schematic representation of FIG. 4, this memory interface 18 can also be an integral component of the respective communication interface.

If the valve unit 51 is not provided with a memory module 71, there is no authorization for the use of program modules 36, 37, 38, as is the case only exemplarily for the two middle valve units 51 of the valve assembly 1 according to FIG. 4. For these two valve units 51, the central processing unit 32 will perform control exclusively with a standard control program that is part of the computer program running in the central processing unit 32.

If, on the other hand, the valve unit 51 is provided with a memory module 71, a query initiated by the central processing unit 32 can be carried out via a communication processor 41 of the respectively associated communication interface 8 to determine whether the respective memory module 71 contains an activation code which represents an authorization for the use of one or more of the program modules 36, 37, 38. For this purpose, in the course of the query, information is read out via the communication interface 8 from the respective memory module 71 of the corresponding valve unit 51, processed by the communication processor 41 and fed into the internal bus protocol and then made available to the central processing unit 32 via the bus line 24.

According to the representation of FIG. 4, it is envisaged, for example, that a communication processor 41 is assigned to each of the valve slots 6. In a valve assembly 1 not represented in more detail, a communication processor can also be connected to a plurality of valve slots 6.

As an example, only a single activation code, symbolically designated by the letter “A”, is stored in the memory module 71 of the valve unit 51 arranged directly adjacent to the control unit 3, so that after this activation code has been transmitted to the central processing unit 32, the program module 36 is enabled there for this valve unit 51. The additional functions of the program module 36 can then be used for subsequent control operations for this valve unit 51. However, these additional functions are only used for the valve unit 51 that has the activation code “A” stored in its memory module 71.

As an example, the activation code “ABC” is stored in the memory module 71 of the valve unit arranged on the far right in FIG. 4, so that after this activation code has been transferred to the central processing unit 32, the release of all three program modules 36, 37, 38 stored in the memory device 33 of the central processing unit 32 can be carried out there for this valve unit 51. The additional functions of the program modules 36, 37, 38 can then be used for subsequent control operations for this valve unit 51.

The respective activation of the valve unit 51 is carried out via control signals, which are generated by the central processing unit 32 individually and, if necessary, using one or more of the program modules 36 to 38 for the respective valve units 51, and are transmitted via the bus line 24 to the respective communication interface 8. In the communication interface 8, a conversion of the control signals takes place in the respective communication processor 41, which, via an associated electrical output stage 42, provides the electrical energy supplied via the supply line 25 to the respective valve unit 51.

As shown in FIG. 4, the valve unit 51 comprises an electric actuator 58 which comprises a solenoid 59, an iron yoke 60, an armature 61 movably received in the solenoid 59, and a return spring 62 arranged between the armature 61 and the iron yoke 60. The electric actuator 58 is configured in such a way that when a coil current is supplied to the solenoid 59, a magnetic force is exerted on the armature 61, so that the latter can compress the return spring 62 and can be moved linearly downwards in accordance with the representation in FIG. 4, thereby approaching the iron core 60. In this case, a displacement of the fluid valve 63, which is shown purely schematically as a 3/2-way valve, from the rest position into a non-shown functional position takes place.

Purely exemplarily, the fluid valve 63 of the valve unit 51 is designed as normally open, so that in the idle state, as shown in FIG. 4, a fluidically communicating connection is provided between the ventilation line 11 in the base plate 4 and a ventilation channel 64 in the valve unit 51 and a working channel 66 in the valve unit 51, which in turn is connected to a working connection 67. In the rest position, which is not shown, the fluid valve 63 interrupts the fluidically communicating connection between the ventilation channel 64 and the working channel 66 and establishes a fluidically communicating connection between the working channel 66 and the venting channel 65. The fluid valve 63, designed purely as an example as a slide valve, comprises in a known manner a valve slide, not shown in more detail, which is moved by the actuator 58 and opens or closes valve seats, not shown in more detail, assigned to the ventilation channel 64 and the venting channel 65, depending on its position.

As a purely exemplary example, it is envisaged that the activation codes stored in the memory module 71 are queried on a recurring basis in order to ensure that the respective valve unit 51 also has the corresponding authorization when the respective program modules 36 or 36 to 38 are used again.

As can be seen from FIG. 4, each of the valve slots 6 is assigned not only the communication interface 8 but also a fluid interface 7, which includes, for example, an aeration connection 9 and a ventilation connection 10. Based on the schematic representation of FIG. 4, an arrangement of the fluid interface 7 and the communication interface 8 is provided that differs from that shown in FIG. 1. The aeration connection 9 is connected via a ventilation line 11 to an aeration inlet 14, which is assigned to the end plate 5 purely by way of example. The ventilation connection 10 is connected via a ventilation line 12 to a ventilation outlet 15, which is assigned to the cover plate 5 purely by way of example.

As can be seen from the representation in FIG. 1, each of the valve slots 6 comprises the fluid interface 7 and communication interface 8 already described in connection with FIG. 4 and is designed for plug-in assembly of the valve unit 51 in a spatial direction which, according to the representation in FIG. 1, essentially corresponds to the vertical. This spatial direction is also symbolized by a dashed connecting line between the valve unit 51, which is arranged above the valve assembly 1, and the communication interface 8.

The valve unit 51 has a valve housing 57 that is divided into an actuator module 52 and a fluid module 53. An electrical actuator, for example a solenoid arrangement, is accommodated in the actuator module. This electric actuator is supplied with electricity via control contacts 54, which project perpendicularly from an underside 55 of the actuator module 52 and which, when the valve unit 51 is coupled to the valve slot 6, are received in control sockets, not shown in more detail, of the communication interface 8. The communication interface 8 thus includes both the control function for the valve unit 51 and the communication function for the valve unit 51. For example, it is envisaged that the communication interface 8 is assigned electrical output stages, not shown, with which an electrical connection between the control contacts 54 and the supply line 25 can be blocked or released, to enable targeted switching off and activation of the actuator. In the fluid module 53, several fluid channels are formed that are not shown, which open out in a manner not shown in more detail on an underside 56 of the fluid module 53 and are connected to an assigned aeration line 11 or ventilation line 12 of the base plate 4 for a fluidically communicating connection.

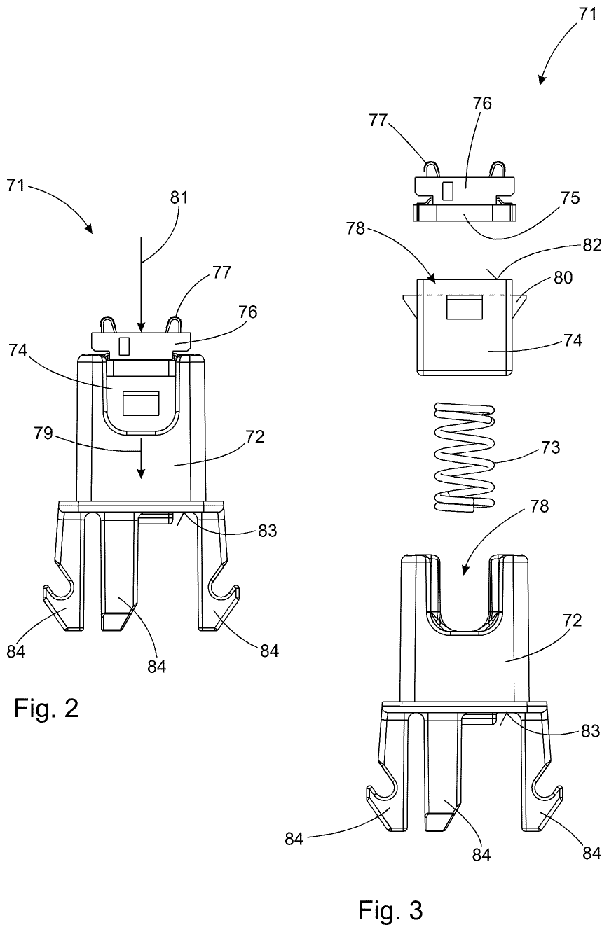

Furthermore, a storage module 71 is attached to the underside 55 of the actuator module 52, which is also designed for electrical contact with non-closer-described, electrically conductive contact surfaces of the communication interface 8 in the base plate 4. The electric contact tongues 77, which are shown in more detail in FIGS. 2 and 3, are designed to be brought into electrical contact with the communication interface 8 when the valve unit 51 is inserted into the respective valve slot 6 of the base plate 4.

As can be seen from the FIGS. 2 and 3, the memory module 71 comprises a module housing 72 that is provided with a recess 78 in which a pressure spring 73 and a pressure plunger 74 are received. The recess 78 and the pressure plunger 74 are matched to one another in such a way that the pressure plunger 74 can be moved linearly with respect to the module housing 72 along a movement path 79, which is shown schematically in FIG. 2. To limit this movement path 79, projections 80 extend laterally from the pressure pad 74, which are received in openings in the module housing 72 that are not shown in more detail. On a front surface 82 of the pressure plunger 74 facing away from the pressure spring 73, a recess is provided, not shown in more detail, into which the storage module 75, designed purely by way of example in the form of a cuboid, can be received to protect it as comprehensively as possible against mechanical influences. Contact tongues 77 extend from the end of the memory module 75, are curved in an arc and pass through a contact carrier 76 made, for example, of electrically insulating material, which is designed to guide the contact tongues 77.

Due to the internal prestressing of the pressure spring 73, the pressure die 74 is pressed in a neutral position, as shown in FIG. 2, with the projections 80 against end surfaces, not shown, of the apertures and can be displaced in the direction of the assembly force 81 when an assembly force 81 occurs, which, as shown in FIG. 2, is directed vertically downwards, be displaced in the direction of the assembly force 81. This ensures that the contact tongues 77, which serve to make contact with contact surfaces of the communication interface 8 that are not shown, are always subjected to a sufficiently large mechanical prestress and thus have the lowest possible electrical contact resistance to the communication interface 8.

On a bottom side 83 facing away from the recess 78 of the module housing 72, the module housing 72 is provided, purely by way of example, with a plurality of latching hooks 84 that are configured for a form-fitting coupling with the actuator module 52. As a purely exemplary embodiment, the latching hooks 84 are designed such that, after the storage module 71 has been mounted on the actuator module 52, they can no longer be released without the storage module 71 being destroyed.

The following procedure can be provided for proper use of the valve assembly 1: First, the valve assembly 1 is put together as an assembly consisting of the connection module 2, control unit 3, base plate 4 and end plate 5 according to a configuration defined by the end user. In this case, and in deviation from the representation in FIG. 1, it may be the case that the base plate 4 has fewer or more than the four valve slots 6 shown in FIG. 1 purely by way of example. When the components are put together-connection module 2, control unit 3, base plate 4 and end plate 5—all the electrical and fluidic connections required for the operation of the valve assembly 1 are created; for this purpose, the aforementioned components can be provided with corresponding electrical plug connections, fluid channels and fluid seals. In a subsequent step, valve units 51 are placed on the valve slots 6 of the base plate 4, wherein these valve units 51, according to the schematic representation of FIG. 4, can be partially equipped with a memory module 71 or can be placed on the respective valve slot 6 without such a memory module 71.

When the valve assembly 1 is put into operation electrically, for which initially only the provision of electrical energy at the energy connection 22 is required, an exchange of information takes place via the internal bus connection of the bus line 24 between the central processing unit 32 and the communication interfaces 8. During this exchange of information, request signals are also output from the central processing unit 32 to the individual communication interfaces 8, whereby the individual communication interfaces 8 carry out a read operation for the memory modules 71 of the valve units 51. For those valve units 51 that are equipped with a memory module 71, a feedback message can be sent from the respective communication interface 8 via the bus line 24 to the central processing unit 32, which contains the information read from the respective memory module 71 for further processing in the central processing unit. For those valve units that are not equipped with a memory module 71, the feedback from the respective communication interface merely contains the information that no read operation could be performed.

In the central processing unit 32, the information read out from the memory module 71 is evaluated to determine whether the respective valve unit 51 has an authorization for the use of program modules 36 to 38 in the form of a corresponding activation code. If this is the case, the respective valve unit 51 can be activated by incorporating the respective program modules 36 to 38. If the communication interface 8 of the valve unit 51 was unable to extract any information when attempting to read, either because no memory module 71 is assigned or because the memory module 71 contains no usable information, only a standard valve control stored in the central processing unit 32 is used when this valve unit is subsequently activated. For example, it may be provided to repeat the read-out process cyclically or acyclically to ensure that the permission to use the respective program modules 36 to 38 for the corresponding valve unit 51 continues to exist, which could be questioned in particular after a valve unit has been replaced.

Depending on the design of the communication interface 8 and the memory module 71, individual information can also be written from the central processing unit 32 to the respective memory module 71. This individual information is information that can be used to draw conclusions about a state of use, particularly a state of wear, of the respective valve unit. For example, it may be provided that a number of switching cycles for the respective valve unit is stored in the memory module 71. In addition, or alternatively, it may be provided that a temperature profile or at least a maximum temperature that has occurred during the use of the valve assembly 1 is stored in the respective memory module. Storage of other wear information, such as a maximum working pressure to which the respective valve unit 51 was subjected or a maximum switching frequency with which the respective valve unit 51 was subjected, can also be provided.

Alternatively, or additionally, information such as the valve type of the valve unit 51, a manufacturer-specific product code of the valve unit 51, service life characteristics such as a maximum number of switching cycles for the valve unit 51 can also be written to the respective memory module 71. Furthermore, it may be provided that a user-specific switching cycle limit is written to the respective memory module 71 and that the associated communication processor 41 stores each switching operation of the valve unit and generates a warning message when the switching cycle limit is exceeded, in order to give a reference, for example to the central processing device 32 or a higher-level machine control, that the valve unit 51 should be replaced as a precaution. Furthermore, it can also be provided that the communication processor 41 is configured in such a way that a valve unit 51 attached to the valve slot 6 is checked to see whether it is intended for this valve slot 6 or is possibly not able to fulfill the function intended for this valve slot 6 due to a faulty assembly. This configuration of the communication processor 41 can be provided by a higher-level control to the valve assembly 1 and can, in the event of deviations, result in the communication processor 41 issuing an error message. Alternatively or additionally, it can also be provided that the communication processor 41 recognizes that a valve unit 51 has been replaced and, in a first step after the valve unit 51 has been replaced, checks whether the newly inserted valve unit 51 has at least the same range of functions as the valve unit previously attached to this valve slot 6 and, in the event of a deviation, can output an error message.

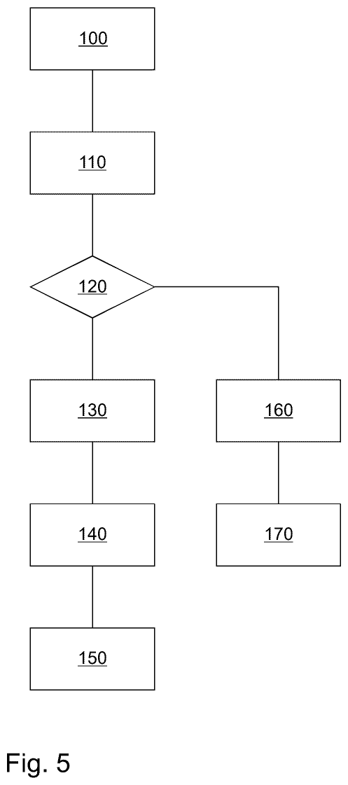

The flow chart shown in FIG. 5 shows in a strictly schematized way the essential steps required for the control unit 3 to use program modules. The reference signs introduced in the above description of the figures are used for the components mentioned below in connection with the flow chart of FIG. 5 that are not shown in FIG. 5.

In step 100, a read access is made from the control unit 3 of the valve assembly 1 to the electronic memory 75 of the memory module 71 associated with the valve unit 51 coupled to the valve assembly 1.

In step 110, a data set stored in the electronic memory 75 is processed in the control unit 3 of the valve assembly 1 to identify at least one activation code contained in the data set. This involves, for example, a comparison of the data set, also referred to as information, with an activation table stored in the control unit 3.

In step 120, the condition is checked to see if the data set contains at least one activation code. If this is the case, processing continues with step 130. If this is not the case, processing continues with step 160.

In step 130, those program modules for which there is a match between the read-out information and the activation table are loaded from a program module memory of the control into a main memory of the control and can then be used for the subsequent control of the respective valve unit 51.

In step 140, the control signals for the valve unit 51 are calculated with the aid of the released program modules loaded into the main memory of the control.

In step 150, the control signals, which have been calculated by the control unit 3 using at least one program module, are provided to the valve unit 51.

In step 160, which is carried out if there is no match between the read-out information and the activation table, control signals for the valve unit 51 are calculated without accessing program modules stored in the program module memory of the controller.

In step 170, the control signals, which were calculated by the control unit 3 without using at least one program module, are provided to the valve unit 51.

1. A valve assembly for supplying compressed air consumers, having a base plate on which a plurality of valve slots are formed, each valve slot having a fluid interface and a communication interface, the communication interface being connected to a control unit which provides electrical signals to the communication interface and receives electrical signals from the communication interface, and with at least one valve unit which is arranged on one of the valve slots and is connected to the fluid interface and to the communication interface, wherein the control unit reads a memory module which is assigned to the respective valve unit and, depending on a result of the read operation, blocks or enables program modules stored in a control memory of the control unit, and uses only enabled program modules for the control of the respective valve unit.

2. The valve assembly according to claim 1, wherein the memory module has an electronic memory.

3. The valve assembly according to claim 1, wherein the control unit comprises a central processing unit for external communication with a higher-level control unit and for internal communication with the communication interfaces.

4. The valve assembly according to claim 3 wherein the control unit comprises a plurality of communication processors which are assigned to the respective communication interfaces and which enable internal bus communication with the central processing unit and reading out the respectively assigned memory module via the respective communication interface.

5. The valve assembly according to claim 1, wherein the control unit carries out a cyclically or acyclically recurring read access to the memory module or carries out a cyclically or acyclically recurring write/read access on the memory module.

6. A valve unit for use in a valve assembly, having a valve housing in which a fluid channel is formed, which fluid channel extends from an inlet connection to an outlet connection and which comprises a valve seat, wherein a valve member being arranged in the fluid channel, which valve member can be moved in a manner such that it sealingly engages with the valve seat in a blocking position and is arranged at a distance from the valve seat in a release position, an electric actuator being arranged in the valve housing, which actuator provides a movement for the valve member, wherein at least two control contacts which are fixed to the valve housing are formed on an outer surface of the valve housing and are electrically connected to the actuator, and a memory module being arranged on the outer surface of the valve housing, comprising a memory interface which is connected to an electronic memory accommodated in the memory module and wherein the control contacts and the memory interface are provided for a coupling to a communication interface of a valve assembly.

7. The valve unit according to claim 6, wherein the memory module is a separate assembly and is connected mechanically to the valve housing.

8. The valve unit according to claim 6, wherein the memory interface has at least two memory contacts to provide an electrical connection to the communication interface of the valve assembly to allow read access or read/write access from the valve assembly to the electronic memory.

9. The valve unit according to claim 6, wherein the memory interface has an optical interface for contactless optical energy coupling and for contactless optical signal output between an optical read-out device of the communication interface of the valve assembly and the electronic memory accommodated in the memory module to enable read access or read/write access to the electronic memory.

10. The valve unit according to claim 6, wherein the valve housing comprises a fluid module and an actuator module, the fluid module comprising the fluid channel, the inlet connection, the outlet connection, the valve seat and the valve member, wherein the actuator module comprises the electric actuator and the control contacts, and wherein the fluid module and the actuator module are separate subassemblies that are mechanically connected to one another.

11. The valve unit according to claim 6, wherein the memory module has, on a second end face facing away from the first end face, at least one latching means for a form-fitting mechanical coupling with the valve housing.

12. A method for controlling a valve unit in a valve assembly with the steps: performing a read access from a control unit of a valve assembly to an electronic memory of a memory module associated with a valve unit coupled to the valve assembly, processing a data set stored in the electronic memory of the control unit of the valve assembly in order to identify at least one activation code contained in the data set, releasing a program module which is determined by the activation code and which is stored in a control memory of the control unit, and activating the valve unit with the released program module.
